(19) United States
(12) Patent Application Publication
(10) Pub. No.: US 2015/0229122 A1
(43) Pub. Date: Aug. 13, 2015

(54) METHOD AND DEVICE FOR RECOGNIZING A SHORT CIRCUIT IN A PWN DRIVER CIRCUIT

(71) Applicant: Robert Bosch GmbH, Stuttgart (DE)

(72) Inventors: Matthias SIEMSS, Gomaringen (DE); Ruediger KARNER, Kornwestheim (DE)

(21) Appl. No.: 14/621,145

(22) Filed: Feb. 12, 2015

(30) Foreign Application Priority Data
Feb. 13, 2014 (DE) 10 2014 202 678.4

(51) Int. Cl. H02H 9/02

(52) U.S. Cl. CPC H02H 9/02

(57) ABSTRACT

A method for recognizing a short circuit in a PWM driver circuit, the PWM driver circuit including a PWM modulator and a power stage unit, and the power stage unit provides an output signal using a control signal which is provided by the PWM modulator. The method includes analyzing a voltage value of the output signal in response to a change in the signal level of the control signal and/or a point in time of the change in the signal level. The analyzing also takes place using a predefined threshold value for assessing the voltage value to recognize a short circuit.

### RELATED APPLICATION INFORMATION

The present application claims priority to and the benefit of German patent application no. 10 2014 202 678.4, which was filed in Germany on Feb. 13, 2014, the disclosure of which is incorporated herein by reference.

### FIELD OF THE INVENTION

The present invention relates to a method for recognizing a short circuit in a PWM driver circuit, a corresponding device for recognizing a short circuit in a PWM driver circuit, and a corresponding computer program product.

### BACKGROUND INFORMATION

A pulse width modulation is frequently used instead of a linear control in order to control the power in consumers. Less power loss is thus converted in the power section, since the power is set by the ratio of the current flow time to the idle time. The output driver is switched only between the “on” and “off” states. It is important to recognize this state in order to protect the PWM controller from an overload due to an external short circuit. Since in a pulse width modulation (PWM), both switching states may correspond to a short circuit as well as to the correct function, it is difficult to carry out an evaluation via a simple voltage measurement.

### SUMMARY OF THE INVENTION

Against this background, using the approach presented here, a method for recognizing a short circuit in a PWM driver circuit, a device for recognizing a short circuit in a PWM driver circuit which uses this method, and lastly, a corresponding computer program product, are provided according to the main claims. Advantageous embodiments result from the respective subclaims and the following description.

A method for recognizing a short circuit in a PWM driver circuit is provided, the PWM driver circuit including a PWM modulator and a power stage unit, the power stage unit providing an output signal using a control signal which is provided by the PWM modulator, having a step of analyzing a voltage value of the output signal in response to a change in the signal level of the control signal and/or a point in time of the change in the signal level, and the step of analyzing also taking place using a predefined threshold value for assessing the voltage value in order to recognize a short circuit.

A PWM driver circuit may be understood to mean a circuit or a power electronics system which utilizes a pulse width-modulated signal for controlling an electrical load. The pulse width-modulated signal may be referred to as PWM, PWM signal, or control signal for short. An average value of a voltage may be steplessly set in proportion to the duty factor with the aid of a pulse width-modulated signal or PWM. The PWM modulator may be configured for providing a pulse width-modulated signal as the control signal. The power stage unit may advantageously be configured without overdimensioning, since it is not necessary to compensate for power loss in the event of a short circuit. Thus, the method may advantageously allow a cost-effective configuration of the PWM driver circuit and in particular of the power stage unit.

The present invention is based on a monitoring unit or device for recognizing a short circuit which recognizes the instantaneous state of the driver stage or the PWM driver circuit, and which thus also recognizes an expected voltage value at the driver or the power stage unit. If the measured value deviates from the expected value over a certain time period, it is possible for the driver stage to be switched off, or only for appropriate information to be transmitted to a control unit, depending on the effect of the short circuit. Due to this rapid recognition, the driver stage or power stage unit may be configured to be significantly smaller, since it is overloaded only briefly in the event of a short circuit, and is thus configurable for the nominal power loss which occurs.

It is also advantageous when the voltage value of the output signal is detected in a step of detecting which precedes the step of analyzing. In particular, the voltage value may be detected using an A/D converter. A discrete value of the voltage of the output signal may advantageously be detected and provided to the step of analyzing for further processing. By use of an A/D converter, the output signal may be cost-effectively detected with high accuracy in order to be further processed in the step of analyzing.

It is also advantageous when, in a step of comparing which precedes the step of analyzing, the output signal is compared to the predefined threshold value in order to obtain a comparator signal. The comparator signal, and at the same time or alternatively, a value of the comparator signal, may be analyzed in the step of analyzing in response to the change in the signal level. The comparator signal may deliver a piece of information concerning whether the output signal is larger or smaller than the predefined threshold value. The comparator signal may represent a binary piece of information. The comparator signal may be easily processed by a microprocessor. A direct response may thus advantageously be made to the comparison in the step of analyzing. A processing speed may advantageously be improved in this way. In addition, a comparator may be implemented in a cost-effective manner.

In addition, the predefined threshold value may be determined in a step of determining which precedes the step of analyzing, using a piece of information concerning the change in the signal level. The information concerning the change in the signal level may thus include a piece of information about a rising edge, and at the same time or alternatively, may include a piece of information about a falling edge, of the control signal. Furthermore, the predefined threshold value may be determined in a step of determining which precedes the step of analyzing, using a piece of information concerning a circuit topology. In the step of analyzing or in the step of comparing, the predefined threshold value at the point in time of a rising edge may differ from the predefined threshold value at the point in time of a falling edge. Characteristics in the output signal at the corresponding points in time may thus advantageously be better recognized or evaluated.

The voltage value may be analyzed in the step of analyzing, using a piece of information concerning a circuit topology. In particular, a distinction may be made between the circuit topology as a high-side driver, and at the same time or alternatively, the circuit topology as a low-side driver.

Thus, the predefined threshold value for a circuit topology as a low-side driver may be differentiated from a circuit topology as a high-side driver. For the same control signal the output signal may be different, depending on the circuit topology. This may be taken into account in the step of analyzing or in the step of comparing.

In addition, in the step of analyzing,
when the circuit topology of the PWM driver circuit represents a high-side driver, for a change in the signal level which follows a low signal level of the PWM signal, a voltage value which is above the predefined threshold value may be recognized as a short circuit at a high potential, and at the same time or alternatively,
for a change in the signal level which follows a high signal level of the PWM signal, a voltage value which is below the predefined threshold value may be recognized as a short circuit to the reference potential and/or ground, and at the same time or alternatively,
when the circuit topology represents a low-side driver, for a change in the signal level which follows a low signal level of the PWM signal, a voltage value which is below the predefined threshold value may be recognized as a short circuit to the reference potential, and at the same time or alternatively,
for a change in the signal level which follows a high signal level of the PWM signal, a voltage value which is above the predefined threshold value may be recognized as a short circuit at a high potential.

In a step of providing which follows the step of analyzing, an error signal may be provided if a short circuit is recognized in the step of analyzing. In particular, the PWM modulator, and at the same time or alternatively, the power stage unit, may be controlled using the error signal.

When the circuit topology of the PWM driver circuit represents a high-side driver, and for a change in the signal level which follows a low signal level of the PWM signal, a voltage value which is above the predefined threshold value is recognized as a short circuit at a high potential in the step of analyzing, in the step of providing, the error signal may include a piece of information concerning a short circuit to a high potential.

When the circuit topology of the PWM driver circuit represents a high-side driver, and for a change in the signal level which follows a high signal level of the PWM signal, a voltage value which is below the predefined threshold value is recognized as a short circuit to the reference potential and/or ground in the step of analyzing, in the step of providing, the error signal may include a piece of information concerning a short circuit to the reference potential and/or ground, and may cause a shutoff of the power stage unit or the PWM driver circuit.

When the circuit topology of the PWM driver circuit represents a low-side driver, and for a change in the signal level which follows a low signal level of the PWM signal, a voltage value which is below the predefined threshold value is recognized as a short circuit to the reference potential and/or ground in the step of analyzing, in the step of providing, the error signal may contain a piece of information concerning a short circuit to the reference potential and/or ground.

When the circuit topology of the PWM driver circuit represents a low-side driver, and for a change in the signal level which follows a high signal level of the PWM signal, a voltage value which is above the predefined threshold value is recognized as a short circuit to a high potential in the step of analyzing, in the step of providing, the error signal may contain a piece of information concerning a short circuit to a high potential, and may cause a shutoff of the power stage unit or the PWM driver circuit.

The approach presented here also provides a device which is configured for carrying out, controlling, or implementing the steps of one variant of a method provided here in appropriate devices. The underlying object of the present invention may also be achieved quickly and efficiently by this embodiment variant of the present invention in the form of a device.

In the present context, a device may be understood to mean an electrical device which processes sensor signals and outputs control and/or data signals as a function thereof. The device may include an interface which may have a hardware and/or software configuration. In a hardware configuration, the interfaces may be part of a so-called system ASIC, for example, which contains various functions of the device. However, it is also possible for the interfaces to be dedicated integrated circuits, or to be at least partially composed of discrete components. In a software configuration, the interfaces may be software modules which are present on a microcontroller, for example, in addition to other software modules.

Also advantageous is a computer program product or computer program including program code which may be stored on a machine-readable carrier or storage medium such as a semiconductor memory, a hard drive, or an optical memory, and used for carrying out, implementing, and/or controlling the steps of the method according to one of the above-described specific embodiments, in particular when the program product or program is executed on a computer or a device.

The approach presented here is explained in greater detail below as an example, with reference to the accompanying drawings.

### BRIEF DESCRIPTION OF THE DRAWINGS

FIG. 1 shows a block diagram of a PWM driver circuit as a high-side driver together with a device for recognizing a short circuit according to one exemplary embodiment of the present invention.

FIG. 2 shows a block diagram of a PWM driver circuit as a low-side driver together with a device for recognizing a short circuit according to one exemplary embodiment of the present invention.

FIG. 3a shows a signal curve of a control signal of a PWM driver circuit according to one exemplary embodiment of the present invention.

FIG. 3b shows a signal curve of an output signal of a PWM driver circuit as a high-side driver according to one exemplary embodiment of the present invention.

FIG. 3c shows a signal curve of an output signal of a PWM driver circuit as a low-side driver according to one exemplary embodiment of the present invention;

FIG. 4 shows a flow chart of a method for recognizing a short circuit in a PWM driver circuit according to one exemplary embodiment of the present invention.

FIG. 5 shows a block diagram of a device for recognizing a short circuit in a PWM driver circuit according to one exemplary embodiment of the present invention.

### DETAILED DESCRIPTION

In the following description of advantageous exemplary embodiments of the present invention, identical or similar reference numerals are used for the elements having a similar action which are illustrated in the various figures, and a repeated description of these elements is dispensed with.

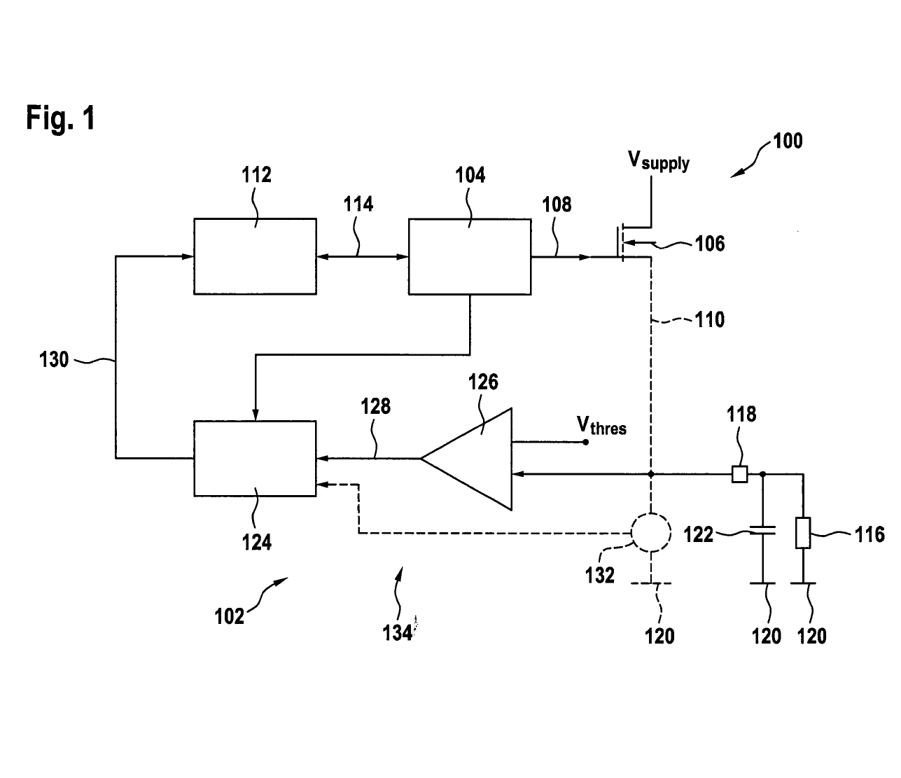

FIG. 1 shows a block diagram of a PWM driver circuit 100 as a high-side driver together with a monitoring stage 102, according to one exemplary embodiment of the present invention. PWM driver circuit 100 includes a PWM modulator 104 and a power stage unit 106. At an output, PWM modulator 104 provides a control signal 108 which is present at an input of power stage unit 106. A supply voltage V_{supply} is present at a terminal of power stage unit 106. An output signal 110 is present at a further terminal of power stage unit 106. PWM modulator 104 is connected to a control unit 112. Control unit 112 provides a control signal 114 for PWM modulator 104. A duty factor or a pulse width of control signal 108, among other things, is settable by control signal 114. A load 116 is connected to the further terminal of power stage unit 106 via a resistor 118. Load 116 is also connected to ground 120. A connection between load 116 and resistor 118 is connected to ground 120 via a capacitor 122.

In one exemplary embodiment, monitoring stage 102 includes a synchronous comparator 124 and a comparator 126. A threshold value voltage Vₜₕᵣₑₛ is present at an input of comparator 126, and output signal 110 is present at a further input of comparator 126. This means that the further input of comparator 126 is connected to the further terminal of power stage unit 106. An output of comparator 126, at which comparator signal 128 is provided, is connected to an input of synchronous comparator 124. PWM modulator 104 is connected to synchronous comparator 124. Synchronous comparator 124 is connected to control unit 112. Synchronous comparator 124 is configured for providing an error signal 130. Error signal 130 may be understood to mean an error message 130.

In one alternative exemplary embodiment, monitoring stage 102 includes synchronous comparator 124 and an A/D converter 132. The A/D converter is connected to the further terminal of power stage unit 106 or to a connecting line between resistor 118 and the further terminal of power stage unit 106. In addition, A/D converter 132 is connected to ground 120. A/D converter 132 provides a voltage value 134 of output signal 110 to synchronous comparator 124.

In the described alternative exemplary embodiment, A/D converter 132 replaces comparator 126 which is used in the above-described exemplary embodiment.

In one exemplary embodiment, threshold value voltage Vₜₕᵣₑₛ or predefined threshold value Vₜₕᵣₑₛ is determined, and at the same time or alternatively, is provided, by synchronous comparator 124, or alternatively, by a threshold value device of monitoring stage 102.

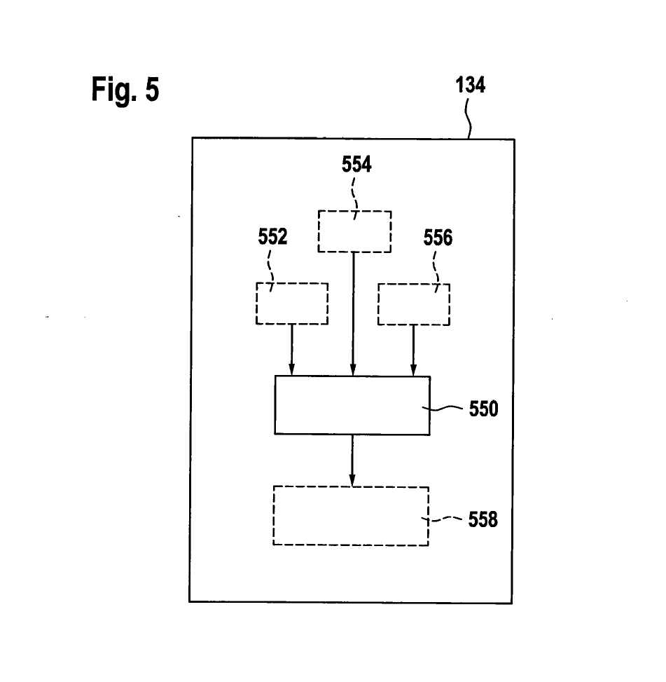

Monitoring stage 102 includes a device 134 for recognizing a short circuit of PWM driver circuit 100. Device 134 includes a portion of, or all, devices of monitoring stage 102. Device 134 is described in greater detail in FIG. 5.

Device 134 provides an automatic short circuit recognition in PWM driver circuits 100.

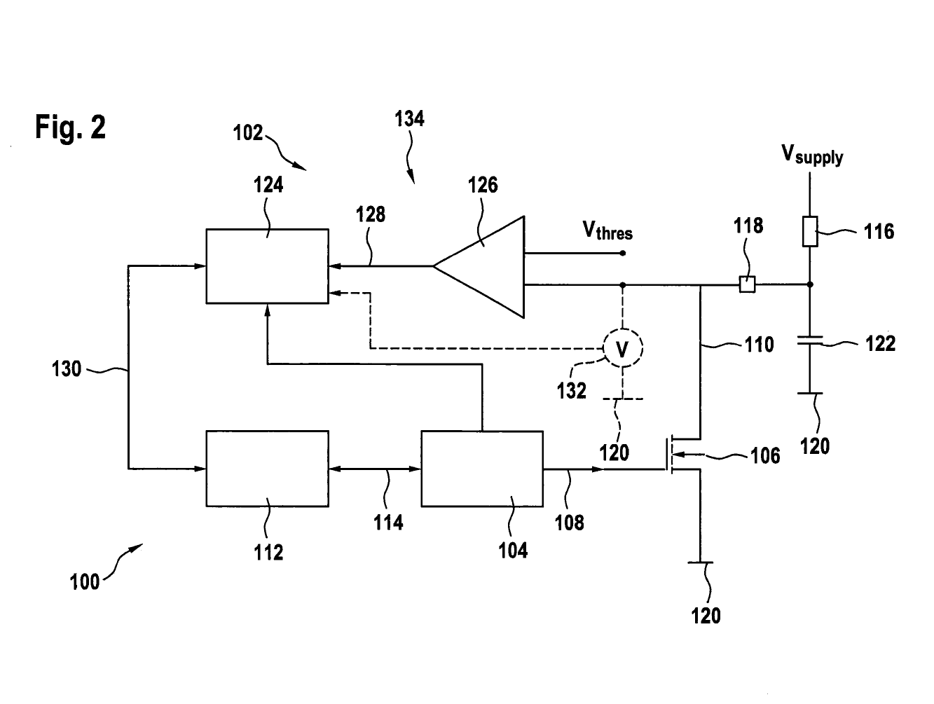

FIG. 2 shows a block diagram of a PWM driver circuit 100 as a low-side driver together with a monitoring stage 102 according to one exemplary embodiment of the present invention. PWM driver circuit 100 largely corresponds to PWM driver circuit 100 shown and described in FIG. 1, with the difference that a ground terminal 120 and supply voltage V_{supply} are interchanged; i.e., supply voltage V_{supply} is present at a terminal of load 120, and a terminal of power stage unit 106 is connected to ground 120.

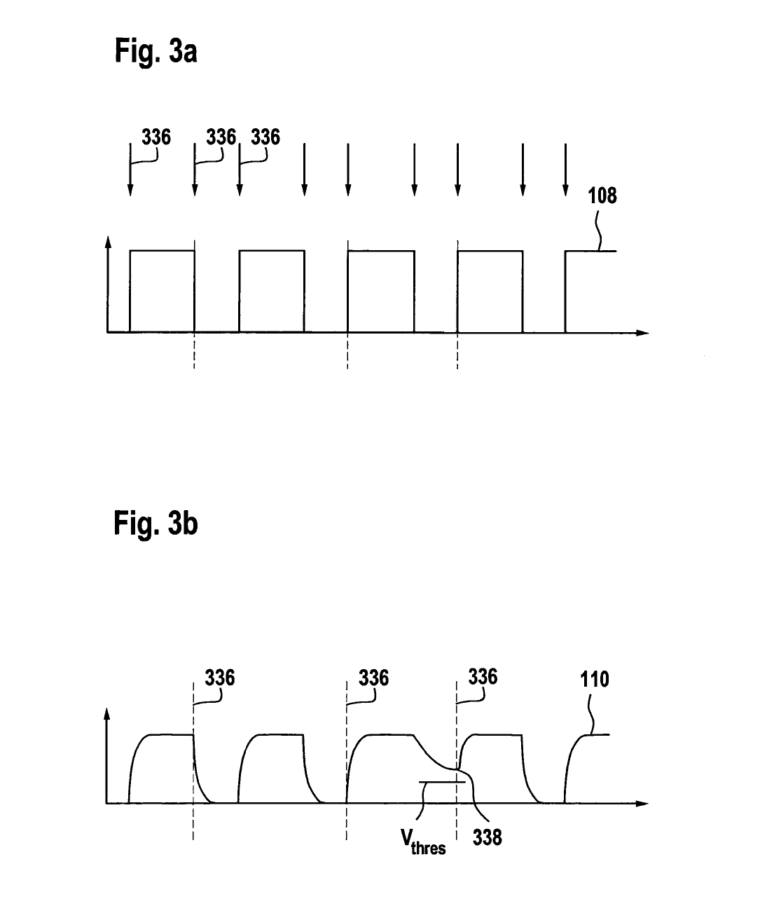

As is apparent from FIG. 1 and FIG. 2, the circuit may be configured with a voltage measurement (A/D converter 132) as an analog or digital measurement, or also with a simple comparator 126. Circuit 100 functions regardless of whether the power stage is a high-side driver (FIG. 1) or a low-side driver (FIG. 2). The monitoring circuit functions in such a way that for each edge change of PWM 108, i.e., control signal 108, generated by PWM modulator 104, a synchronous comparator 124 checks the result of a voltage measurement or a voltage comparison as to whether the voltage at power stage 106 or power stage unit 106 corresponds to the expected value. To avoid faulty measurements or misinterpretations due to transient effects, the applied voltage is implemented exactly at the point in time of the logical change in potential of PWM 108, as illustrated in subsequent FIGS. 3a through 3c. Since the power section always responds with a delay with respect to the control section, the state prior to the instantaneous edge change is always assessed. In the case of a high-side driver (FIG. 1 and FIG. 3b), in the switched-off state of the driver a level below a threshold to be defined is awaited. If the measured voltage is above the threshold, a short circuit to a high potential is present. The power stage does not have to be switched off, since it does not have to supply additional power. It is sufficient to transfer a piece of information to a control or monitoring unit 112. If the driver stage is switched on, the level must be above a corresponding threshold. If this is not the case, a short circuit to the reference potential is present, in the normal case, to ground. In this case the output stage must be switched off as quickly as possible, since it now experiences a power loss that is above the nominal load. In addition, control or monitoring unit 112 is once again informed. For the sake of simplicity, both thresholds may be at the same level, but for optimization purposes they may also be at different potentials. The transfer of information from synchronous comparator 124 to control and monitoring unit 112 may take place via status lines or also via appropriate bus systems. In the case of a low-side driver, the procedure is analogous to the above description, except that for a short circuit to the higher potential, only the power stage is switched off, since in this case the higher power loss occurs at the power stage.

As a further advantage, the time during which the power output stage is subjected to load by a short circuit may be added up by control and monitoring unit 112, and the protective shutoff of the output stage may thus be carried out independently of the duty cycle of PWM 108. This means that only the integral of the power loss results in switching off of the power stage.

Control signal 108 and output signal 110 are each described in subsequent FIG. 3a through FIG. 3c with reference to one exemplary embodiment, certain detection points or sample points being particularly emphasized.

FIG. 3a shows a signal curve of a control signal 108 of a PWM driver circuit according to one exemplary embodiment of the present invention. PWM driver circuit 100 may be an exemplary embodiment of a PWM driver circuit 100 described in FIG. 1 or FIG. 2. Control signal 108 is illustrated in a Cartesian coordinate system. The abscissa of the Cartesian coordinate system represents a time axis, and the ordinate of the Cartesian coordinate system represents an amplitude of control signal 108. Control signal 108 has a rectangular shape, a duty factor being modulatable at a constant frequency of a rectangular pulse. In the exemplary embodiment shown, the duty factor of control signal 108 is constant over the illustrated time interval. In illustrated control signal 108, the electrical voltage alternates between two predefined voltage values. In one particular exemplary embodiment, control signal 108 is a TTL signal.

Upon each change in the signal level of control signal 108, a detection point or a sample point is generated at a point in time 336 of the change in the signal level. A change in the signal level is characterized by a rising edge, or alternatively is characterized by a falling edge.

FIG. 3b shows a signal curve of an output signal 110 of a PWM driver circuit as a high-side driver according to one exemplary embodiment of the present invention. PWM driver circuit 100 may be an exemplary embodiment of a PWM driver circuit 100 described in FIG. 1. Output signal 110 is illustrated in a Cartesian coordinate system. The abscissa of the Cartesian coordinate system represents a time axis, and the ordinate of the Cartesian coordinate system represents an amplitude of output signal 110. The signal curve of output signal 110 is similar to the signal curve of control signal 108 shown in FIG. 3a, upon a change in the signal level the signal rising more slowly and falling more slowly than the signal curve of control signal 108. Second and fifth points in time 336 of the change in the signal level are particularly emphasized by a vertical dashed line. At second point in time 336 of the change in the signal level, the expected value is high. At fifth point in time 336 of the change in the signal level, the expected value is low. Seventh point in time 336 of the change in the signal level is also particularly emphasized by a vertical dashed line. The low expected value is not reached here, since a short circuit to a high potential is present. An intersection point of the signal curve of output signal 110 with point in time 336 of the change in the signal level denoted by the dashed line represents voltage value 338 of output signal 110. Threshold value voltage Vₜₕᵣₑₛ is situated between voltage value 338 and the reference potential.

FIG. 3c shows a signal curve of an output signal 110 of a PWM driver circuit as a low-side driver according to one exemplary embodiment of the present invention. PWM driver circuit 100 may be an exemplary embodiment of a PWM driver circuit 100 described in FIG. 2. Output signal 110 is illustrated in a Cartesian coordinate system. The abscissa of the Cartesian coordinate system represents a time axis, and the ordinate of the Cartesian coordinate system represents an amplitude of output signal 110. The signal curve of output signal 110 is similar to the inverted signal curve of a control signal 108 shown in FIG. 3a, upon a change in the signal level the signal rising more slowly and falling more slowly than the signal curve of control signal 108. Second and fifth points in time 336 of the change in the signal level are particularly emphasized by a vertical dashed line. At second point in time 336 of the change in the signal level, the expected value is low. At fifth point in time 336 of the change in the signal level, the expected value is high. Seventh point in time 336 of the change in the signal level is also particularly emphasized by a vertical dashed line. The high expected value is not reached here, since a short circuit to a low potential or reference potential is present. An intersection point of the signal curve of output signal 110 with point in time 336 of the change in the signal level denoted by the dashed line represents voltage value 338 of output signal 110. Threshold value voltage Vₜₕᵣₑₛ is situated between voltage value 338 and the high potential.

In one exemplary embodiment, threshold value voltage Vₜₕᵣₑₛ is the same for an expected low potential and an expected high potential. In one alternative exemplary embodiment, these two threshold value voltages Vₜₕᵣₑₛ are different. In addition, the threshold value voltage Vₜₕᵣₑₛ may be a function of the circuit diagram topology.

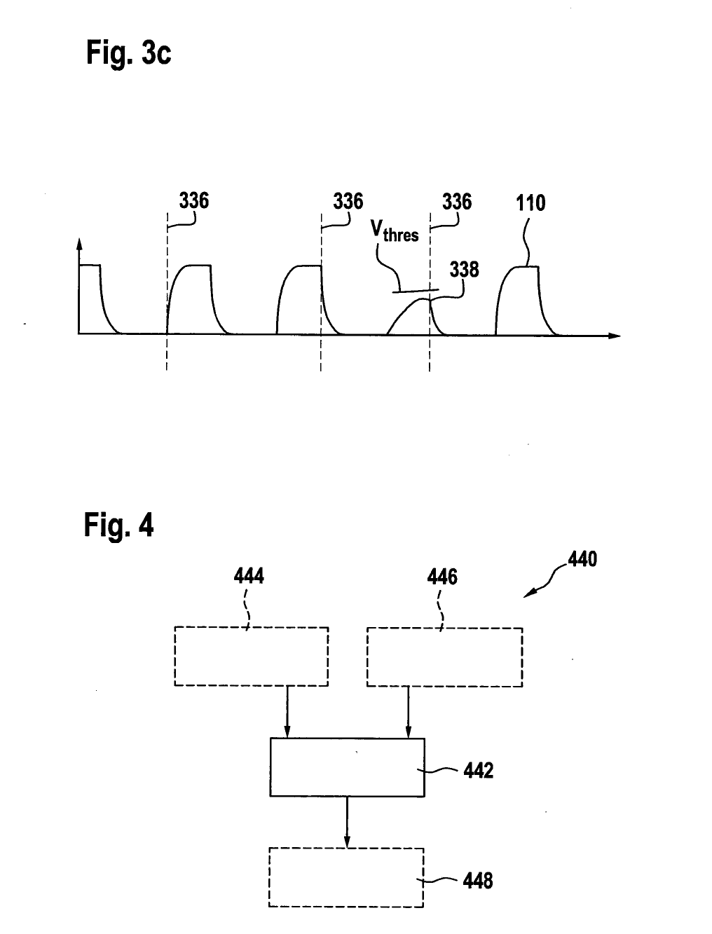

FIG. 4 shows a flow chart of a method 440 for recognizing a short circuit in a PWM driver circuit according to one exemplary embodiment of the present invention. PWM driver circuit 100 may be an exemplary embodiment of a PWM driver circuit 100 described in FIG. 1 or FIG. 2. In one exemplary embodiment, the PWM driver circuit includes a PWM modulator and a power stage unit, the power stage unit providing an output signal using a control signal which is provided by the PWM modulator. Method 440 includes a step 442 of analyzing a voltage value of the output signal in response to a change in the signal level of the control signal and/or a point in time of the change in the signal level. Step 442 of analyzing also takes place using a predefined threshold value for assessing the voltage value in order to recognize a short circuit.

In one optional exemplary embodiment, method 440 includes a step 444, which precedes step 442 of analyzing, of detecting the voltage value of the output signal. The detection of the voltage value in step 444 of detecting takes place in particular using an A/D converter. In one alternative variant, method 440 includes step 446, which precedes step 442 of analyzing, of comparing the output signal to the predefined threshold value in order to obtain a comparator signal. The comparator signal and/or a value of the comparator signal in response to the change in the signal level is/are analyzed in step of analyzing 442.

In one exemplary embodiment which is not illustrated, method 440 includes a step, which precedes the step of analyzing, of determining the predefined threshold value, using a piece of information concerning the change in the signal level.

The voltage value is optionally analyzed in step 442 of analyzing, using a piece of information concerning a circuit topology. In particular, a distinction is made between the circuit topology as a high-side driver and/or the circuit topology as a low-side driver.

In one exemplary embodiment, method 440 includes an optional step 448, which follows step 442 of analyzing, of providing an error signal. Step 448 of providing an error signal is carried out when a short circuit is recognized in step 442 of analyzing, in particular the PWM modulator, and at the same time or alternatively, the power stage unit, being controlled using the error signal.

FIG. 5 shows a block diagram of a device 134 for recognizing a short circuit in a PWM driver circuit according to one exemplary embodiment of the present invention. PWM driver circuit 100 may be an exemplary embodiment of a PWM driver circuit 100 described in FIG. 1 or FIG. 2. In one exemplary embodiment, the PWM driver circuit includes a PWM modulator and a power stage unit, the power stage unit providing an output signal using a control signal which is provided by the PWM modulator. Device 134 is configured for carrying out the method, shown in FIG. 4, for recognizing a short circuit. For this purpose, device 134 includes a device 550 for analyzing a voltage value of the output signal in response to a change in the signal level of the control signal and/or a point in time of the change in the signal level. Device 550 for analyzing is also configured for assessing the voltage value, using a predefined threshold value, in order to recognize a short circuit.

In one optional exemplary embodiment, device 134 includes a device 552 for detecting the voltage value of the output signal. Device 552 for detecting may be A/D converter 132 shown in FIG. 1 or FIG. 2.

In one optional exemplary embodiment, device 134 includes a device 554 for comparing the output signal to the predefined threshold value in order to obtain a comparator signal. In one exemplary embodiment, device 554 may be comparator 126 shown in FIG. 1 or FIG. 2.

In one exemplary embodiment, device 134 includes an optional device 556 for determining the predefined threshold value. Device 556 for determining is configured for reading in a piece of information concerning the change in the signal level, and at the same time or alternatively, a piece of information concerning a circuit topology, and determining the predefined threshold value, using the read-in pieces of information. In the circuit topology, a distinction is made, for example, between a PWM driver circuit as a high-side driver, as illustrated in FIG. 1, for example, and a PWM driver circuit as a low-side driver, as illustrated in FIG. 2, for example.

In one exemplary embodiment, device 134 includes an optional device 558 for providing an error signal when a short circuit is recognized in device 550 for analyzing.

Depending on the exemplary embodiment, device 550 for analyzing shown in FIG. 5 corresponds to synchronous comparator 124 shown in FIG. 1 or FIG. 2, is a part of same, or includes same.

One aspect of the concept presented here is to provide an option for carrying out the short circuit assessment, in particular automatically, based on a voltage measurement or a voltage comparison as a function of the instantaneous driver status. An error is qualified only when the ascertained voltage value does not match the status expected from the position of the driver. A short circuit recognition is advantageously not carried out just initially, prior to activating the PWM. The output stage is thus protected at all times in the event of a short circuit occurring during operation. Advantageously, no monitoring gaps or long response times result. Destruction in the event of a short circuit is avoidable, even without large-scale overdimensioning of the PWM driver circuit or of the power stage unit.

The exemplary embodiments which are described, and shown in the figures, have been selected only as examples. Different exemplary embodiments may be combined with one another, either completely or with respect to individual features. In addition, one exemplary embodiment may be supplemented by features of another exemplary embodiment.

Furthermore, the method steps provided here may be repeated, and carried out in a sequence different from that described.

If an exemplary embodiment includes an “and/or” link between a first feature and a second feature, this may be construed in such a way that according to one specific embodiment, the exemplary embodiment has the first feature as well as the second feature, and according to another specific embodiment, the exemplary embodiment either has only the first feature or only the second feature.

What is claimed is:

1. A method for recognizing a short circuit in a PWM driver circuit, the method comprising:
analyzing a voltage value of an output signal in response to a change in a signal level of the control signal and/or a point in time of a change in the signal level, wherein the PWM driver circuit includes a PWM modulator and a power stage unit, the power stage unit providing the output signal using the control signal which is provided by the PWM modulator;
wherein the analyzing includes using a predefined threshold value for assessing the voltage value to recognize a short circuit.

2. The method of claim 1, further comprising:
detecting, before performing the analyzing, the voltage value of the output signal.

3. The method of claim 1, further comprising:
comparing, before performing the analyzing, the output signal to the predefined threshold value to obtain a comparator signal, wherein the comparator signal and/or a value of the comparator signal in response to the change in the signal level and/or the point in time of the change in the signal level being analyzed in performing the analyzing.

4. The method of claim 1, further comprising:
determining, before performing the analyzing, the predefined threshold value, using a piece of information concerning the change in the signal level.

5. The method of claim 1, wherein the voltage value is analyzed using a piece of information concerning a circuit topology.

6. The method of claim 1, wherein the analyzing includes at least one of the following:
when the circuit topology of the PWM driver circuit represents a high-side driver, for a change in the signal level which follows a low signal level of the control signal, a voltage value which is above the predefined threshold value is recognized as a short circuit at a high potential,
wherein for a change in the signal level which follows a high signal level of the control signal, a voltage value which is below the predefined threshold value is recognized as a short circuit to the reference potential and/or ground,
wherein when the circuit topology represents a low-side driver, for a change in the signal level which follows a low signal level of the control signal, a voltage value which is below the predefined threshold value is recognized as a short circuit to the reference potential, and
wherein for a change in the signal level which follows a high signal level of the control signal, a voltage value which is above the predefined threshold value is recognized as a short circuit at a high potential.

7. The method of claim 1, further comprising:
providing, after performing the analyzing, an error signal when a short circuit is recognized in the analyzing.

8. A device for recognizing a short circuit in a PWM driver circuit, comprising:
an analyzing arrangement to analyze a voltage value of an output signal in response to a change in a signal level of the control signal and/or a point in time of a change in the signal level, wherein the PWM driver circuit includes a PWM modulator and a power stage unit, the power stage unit providing the output signal using the control signal which is provided by the PWM modulator;
wherein the analyzing includes using a predefined threshold value for assessing the voltage value to recognize a short circuit.

9. A computer readable medium having a computer program, which is executable by a processor, comprising:
a program code arrangement having program for recognizing a short circuit in a PWM driver circuit, by performing the following:
analyzing a voltage value of an output signal in response to a change in a signal level of the control signal and/or a point in time of a change in the signal level, wherein the PWM driver circuit includes a PWM modulator and a power stage unit, the power stage unit providing the output signal using the control signal which is provided by the PWM modulator;
wherein the analyzing includes using a predefined threshold value for assessing the voltage value to recognize a short circuit.

10. The computer readable medium of claim 9, wherein the analyzing includes at least one of the following:
when the circuit topology of the PWM driver circuit represents a high-side driver, for a change in the signal level which follows a low signal level of the control signal, a voltage value which is above the predefined threshold value is recognized as a short circuit at a high potential,
wherein for a change in the signal level which follows a high signal level of the control signal, a voltage value which is below the predefined threshold value is recognized as a short circuit to the reference potential and/or ground,
wherein when the circuit topology represents a low-side driver, for a change in the signal level which follows a low signal level of the control signal, a voltage value which is below the predefined threshold value is recognized as a short circuit to the reference potential, and
wherein for a change in the signal level which follows a high signal level of the control signal, a voltage value which is above the predefined threshold value is recognized as a short circuit at a high potential.

11. The method of claim 1, further comprising:
detecting, before performing the analyzing, the voltage value of the output signal, wherein the voltage value is detected using an A/D converter.

12. The method of claim 1, wherein the voltage value is analyzed using a piece of information concerning a circuit topology, wherein a distinction is made between the circuit topology as a high-side driver and/or the circuit topology as a low-side driver.

13. The method of claim 1, further comprising:
providing, after performing the analyzing, an error signal when a short circuit is recognized in the analyzing, wherein the PWM modulator and/or the power stage unit is controlled using the error signal.

14. The device claim 8, wherein the analyzing includes at least one of the following:
when the circuit topology of the PWM driver circuit represents a high-side driver, for a change in the signal level which follows a low signal level of the control signal, a voltage value which is above the predefined threshold value is recognized as a short circuit at a high potential,
wherein for a change in the signal level which follows a high signal level of the control signal, a voltage value which is below the predefined threshold value is recognized as a short circuit to the reference potential and/or ground,
wherein when the circuit topology represents a low-side driver, for a change in the signal level which follows a low signal level of the control signal, a voltage value which is below the predefined threshold value is recognized as a short circuit to the reference potential, and
wherein for a change in the signal level which follows a high signal level of the control signal, a voltage value which is above the predefined threshold value is recognized as a short circuit at a high potential.
